(19) United States
(12) Patent Application Publication
(10) Pub. No.: US 2026/0362223 A1
(43) Pub. Date: Nov. 12, 2026

(54) LOW LATENCY INDICATION NEGOTIATION PROCEDURE

(71) Applicant: Samsung Electronics Co., Ltd., Suwon-si (KR)

(72) Inventors: Yue Qi, Plano, TX (US); Rubayet Shafin, Frisco, TX (US); Peshal Nayak, Plano, TX (US); Vishnu Vardhan Ratnam, Frisco, TX (US); Boon Loong Ng, Plano, TX (US); Bilal Sadiq, Plano, TX (US)

(21) Appl. No.: 19/655,379

(22) Filed: Apr. 22, 2026

Related U.S. Application Data
(60) Provisional application No. 63/803,302, filed on May 9, 2025.
(60) Provisional application No. 63/803,665, filed on May 10, 2025.
(60) Provisional application No. 63/804,365, filed on May 12, 2025.
(60) Provisional application No. 63/816,203, filed on Jun. 2, 2025.
(60) Provisional application No. 63/821,168, filed on Jun. 10, 2025.
(60) Provisional application No. 63/829,303, filed on Jun. 24, 2025.

(51) Int. Cl. H04W 28/02; H04W 84/12

(52) U.S. Cl. CPC H04W 28/0268; H04W 84/12

(57) ABSTRACT

Methods and systems for a low latency indication negotiation procedure. A method performed by a non-access point (AP) station (STA) includes establishing at least one stream classification service (SCS) stream with an associated AP multi-link device (MLD) that supports a low latency indication (LLI) mode. The method also includes generating an LLI setup request frame including a request to configure the LLI mode with the associated AP MLD device. The LLI setup request frame is a management frame having an LLI Requested subfield set to 1. The method also includes transmitting the LLI setup request frame to the associated AP MLD device. The method also includes receiving an LLI setup response frame from the associated AP MLD device indicating whether the associated AP MLD device accepts the request.

### CROSS-REFERENCE TO RELATED APPLICATIONS AND CLAIM OF PRIORITY

The present application claims priority to U.S. Provisional Patent Application No. 63/803,302, filed on May 9, 2025, U.S. Provisional Patent Application No. 63/803,665, filed on May 10, 2025, U.S. Provisional Patent Application No. 63/804,365, filed on May 12, 2025, U.S. Provisional Patent Application No. 63/816,203, filed on Jun. 2, 2026, U.S. Provisional Patent Application No. 63/821,168, filed on Jun. 10, 2025, and U.S. Provisional Patent Application No. 63/829,303, filed on Jun. 24, 2025. The contents of the above-identified patent documents are incorporated herein by reference.

### TECHNICAL FIELD

The present disclosure relates generally to wireless communication systems. more specifically, the present disclosure relates to a system and method for a low latency indication negotiation procedure.

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

The present disclosure relates generally to wireless communication systems and, more specifically, the present disclosure relates to a system and method for a low latency indication negotiation procedure.

In one embodiment, a method performed by a non-access point (AP) station (STA) is provided. The method includes establishing at least one stream classification service (SCS) stream with an associated AP multi-link device (MLD) that supports a low latency indication (LLI) mode. The method also includes generating an LLI setup request frame including a request to configure the LLI mode with the associated AP MLD device. The LLI setup request frame is a management frame having an LLI Requested subfield set to 1. The method also includes transmitting the LLI setup request frame to the associated AP MLD device. The method also includes receiving an LLI setup response frame from the associated AP MLD device indicating whether the associated AP MLD device accepts the request.

In another embodiment, a method performed by an AP MLD is provided. The method includes generating an LLI setup frame to broadcast a capability of the AP MLD to support an LLI mode. The LLI setup frame is a management frame. The method also includes transmitting the LLI setup frame. The method also includes receiving, from a non-AP STA, an LLI setup request frame including a request to configure the LLI mode. The LLI setup request frame is a management frame having an LLI Requested subfield set to 1. The method also includes transmitting an LLI setup response frame from the associated AP MLD device indicating whether the associated AP MLD device accepts the request.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example LLI setup request and response frame exchange initiated by STAs supporting low latency indication negotiation according to embodiments of the present disclosure;

FIG. 4 illustrates an example LLI negotiation request frame exchange supporting low latency indication negotiation according to embodiments of the present disclosure;

FIG. 5 illustrates an example LLI setup request and response frame exchange initiated by APs supporting low latency indication negotiation according to embodiments of the present disclosure;

FIG. 6 illustrates an example frame exchange on LLI with action policy supporting low latency indication negotiation according to embodiments of the present disclosure;

FIG. 7 illustrates an example LLI enablement field supporting low latency indication negotiation according to embodiments of the present disclosure;

FIGS. 8A-8E illustrate example LLI enablement formats supporting low latency indication negotiation according to embodiments of the present disclosure;

FIG. 9 illustrates an example quality of service (QoS) characteristics element format supporting low latency indication negotiation according to embodiments of the present disclosure;

FIG. 10 illustrates an example QoS characteristics element supporting low latency indication negotiation according to embodiments of the present disclosure;

FIG. 11 illustrates an example frame exchange using a physical layer protocol data unit (PPDU) to solicit LLI supporting low latency indication negotiation according to embodiments of the present disclosure;

FIG. 12 illustrates an example frame exchange using a buffer status report poll (BSRP) to solicit LLI supporting low latency indication negotiation according to embodiments of the present disclosure;

FIG. 13 illustrates an example frame exchange using a block acknowledgment request (BAR) to solicit LLI supporting low latency indication negotiation according to embodiments of the present disclosure;

FIG. 14 illustrates an example A-Control field supporting low latency indication negotiation according to embodiments of the present disclosure;

FIG. 15 illustrates an example flow chart of a method for low latency indication negotiation procedure performed by a non-access point station according to embodiments of the present disclosure; and

FIG. 16 illustrates an example flow chart of a method for low latency indication negotiation procedure performed by an access point multi-link device according to embodiments of the present disclosure.

### DETAILED DESCRIPTION

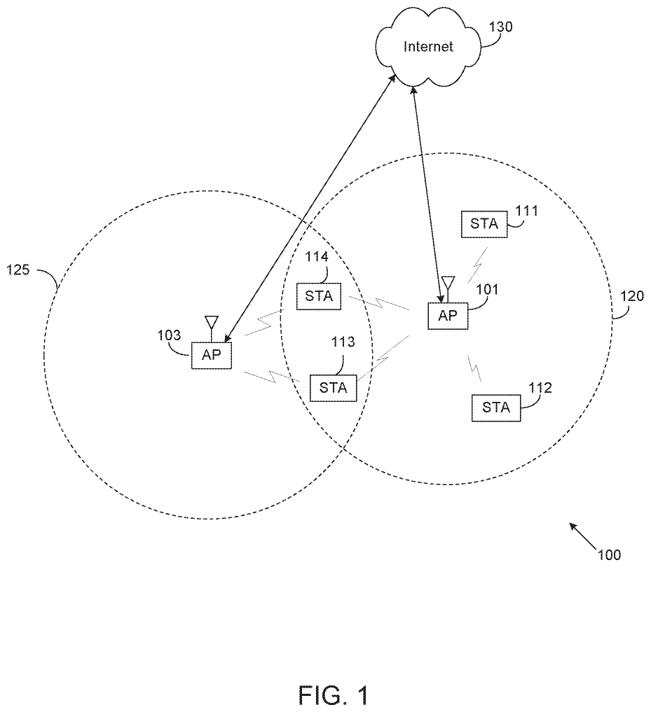

FIG. 1 through FIG. 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following standards description is hereby incorporated by reference into the present disclosure as if fully set forth herein [1] IEEE 802.11-2020, “Wireless LAN Medium Access Control (MAC) and Physical Layer (PHY) Specification.”

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes AP devices 101 and 103. The AP devices 101 and 103 communicate with at least one network 130, such as the Internet, a proprietary Internet Protocol (IP) network, or other data network. The AP device 101 provides wireless access to the network 130 for a plurality of stations (STAs) 111-114 within a coverage area 120 of the AP device 101. The AP devices 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP device also contends for the wireless channel, the AP device may also be referred to as a STA (e.g., an AP device STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP device or contends for a wireless channel in a WLAN, whether the STA is a mobile device (such as a mobile telephone or smartphone) or is normally considered a stationary device (such as a desktop computer, AP device, media player, stationary sensor, television, etc.). This type of STA may also be referred to as a non-AP STA.

In various embodiments of this disclosure, each of the AP devices 101 and 103 and each of the STAs 111-114 may be an MLD. In such embodiments, AP devices 101 and 103 may be AP device MLDs, and STAs 111-114 may be non-AP MLDs. Each MLD is affiliated with more than one STA. For convenience of explanation, an AP device MLD is described herein as affiliated with more than one AP device (e.g., more than one AP device STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with AP devices, such as the coverage areas 120 and 125, may have other shapes, including irregular shapes, depending upon the configuration of the AP devices and variations in the radio environment associated with natural and man-made obstructions.

As described in more detail below, one or more of the AP devices may include circuitry and/or programming for supporting low latency indication negotiation. Although FIG. 1 illustrates one example of a wireless network 100, various changes may be made to FIG. 1. For example, the wireless network 100 could include any number of AP devices and any number of STAs in any suitable arrangement. Also, the AP device 101 could communicate directly with any number of STAs and provide those STAs with wireless broadband access to the network 130. Similarly, each AP device 101-103 could communicate directly with the network 130 and provide STAs with direct wireless broadband access to the network 130. Further, the AP devices 101 and/or 103 could provide access to other or additional external networks, such as external telephone networks or other types of data networks.

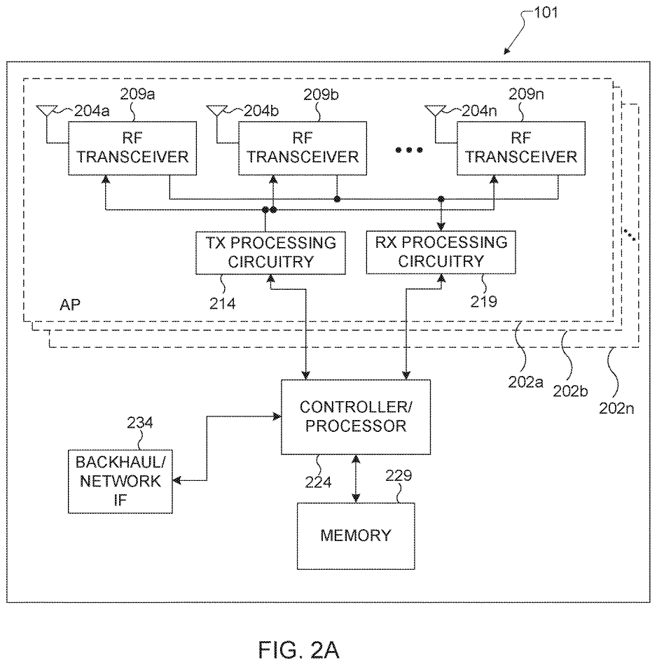

FIG. 2A illustrates an example AP device 101 according to various embodiments of the present disclosure. The embodiment of the AP device 101 illustrated in FIG. 2A is for illustration only, and the AP device 103 of FIG. 1 could have the same or similar configuration. In the embodiments discussed below, the AP device 101 is an AP device MLD. However, AP devices come in a wide variety of configurations, and FIG. 2A does not limit the scope of this disclosure to any particular implementation of an AP device.

The AP device MLD 101 is affiliated with multiple AP devices 202a-202n (which may be referred to, for example, as AP device1-APn). Each of the affiliated AP devices 202a-202n includes multiple antennas 204a-204n, multiple RF transceivers 209a-209n, transmit (TX) processing circuitry 214, and receive (RX) processing circuitry 219. The AP device MLD 101 also includes a controller/processor 224, a memory 229, and a backhaul or network interface 234.

The illustrated components of each affiliated AP device 202a-202n may represent a physical (PHY) layer and a lower media access control (LMAC) layer in the open systems interconnection (OSI) networking model. In such embodiments, the illustrated components of the AP device MLD 101 represent a single upper MAC (UMAC) layer and other higher layers in the OSI model, which are shared by all of the affiliated AP devices 202a-202n.

For each affiliated AP device 202a-202n, the RF transceivers 209a-209n receive, from the antennas 204a-204n, incoming RF signals, such as signals transmitted by STAs in the network 100. In some embodiments, each affiliated AP device 202a-202n operates at a different bandwidth, e.g., 2.4 GHz, 5 GHz, or 6 GHz, and accordingly the incoming RF signals received by each affiliated AP device may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP device 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP device 202a-202n operates at a different bandwidth, e.g., 2.4 GHz, 5 GHz, or 6 GHz, the outgoing RF signals transmitted by each affiliated AP device may be at a different frequency of RF.

The controller/processor 224 can include one or more processors or other processing devices that control the overall operation of the AP device MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP device MLD 101 by the controller/processor 224 including anchor link design for multi-link operation. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP device MLD 101 to communicate with other devices or systems over a backhaul connection or over a network. The interface 234 could support communications over any suitable wired or wireless connection(s). For example, the interface 234 could allow the AP device MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP device MLD 101 may include circuitry and/or programming for supporting low latency indication negotiation. Although FIG. 2A illustrates one example of AP device MLD 101, various changes may be made to FIG. 2A. For example, the AP device MLD 101 could include any number of each component shown in FIG. 2A. As a particular example, an AP device MLD 101 could include a number of interfaces 234, and the controller/processor 224 could support routing functions to route data between different network addresses. As another particular example, while each affiliated AP device 202a-202n is shown as including a single instance of TX processing circuitry 214 and a single instance of RX processing circuitry 219, the AP device MLD 101 could include multiple instances of each (such as one per RF transceiver) in one or more of the affiliated AP devices 202a-202n. Alternatively, only one antenna and RF transceiver path may be included in one or more of the affiliated AP devices 202a-202n, such as in legacy AP devices. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of an STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP device of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to support low latency indication negotiation. In some embodiments, the processor 240 includes at least one microprocessor or microcontroller.

The processor 240 is also capable of executing other processes and programs resident in the memory 260, such as operations for supporting low latency indication negotiation. The processor 240 can move data into or out of the memory 260 as required by an executing process. In some embodiments, the processor 240 is configured to execute a plurality of applications 262, such as applications for supporting low latency indication negotiation. The processor 240 can operate the plurality of applications 262 based on the OS program 261 or in response to a signal received from an AP device. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP device 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

The negotiation procedure for the Low Latency Indication (LLI) feature is currently unclear, and a defined negotiation procedure may be necessary to initiate an LLI session. The following discussion addresses how such negotiation may be conducted using management frames and dedicated request and response frames.

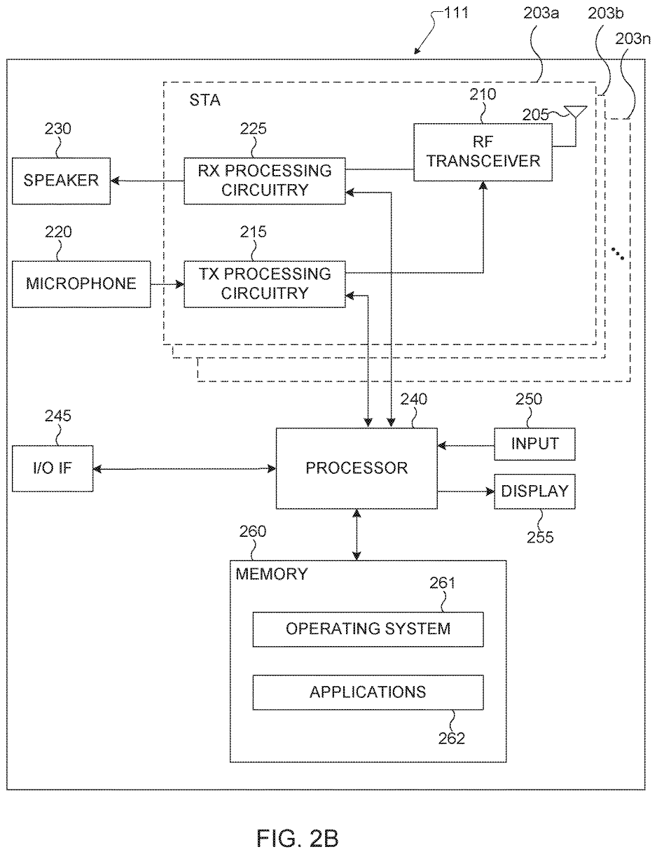

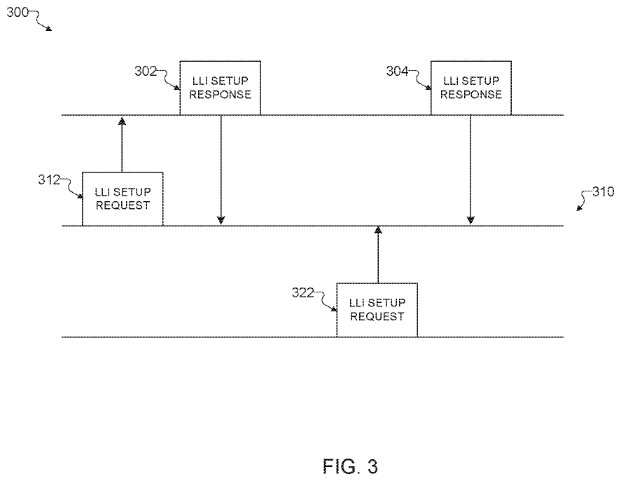

FIG. 3 illustrates an example LLI setup request and response frame exchange 300 according to embodiments of the present disclosure. FIG. 4 illustrates an example LLI negotiation request frame exchange 400 according to embodiments of the present disclosure. For ease of explanation, the LLI setup request and response frame exchange 300 will be described as including one or more components of the wireless network 100 of FIG. 1, such as the non-AP STA 111; however, the LLI setup request and response frame exchange 300 could be implemented using any other suitable device or system. The embodiment of the LLI setup request and response frame exchange 300 shown in FIG. 3 is for illustration only. Other embodiments of the LLI setup request and response frame exchange 300 could be used without departing from the scope of this disclosure.

As shown in FIG. 3, the frame exchange 300 includes one or more LLI setup requests 310, such as a first LLI setup request frame 312 and a second LLI setup request frame 322, transmitted by one or more non-AP STAs, such as a first non-AP STA and a second non-AP STA, respectively. An AP MLD may response to each of the one or more LLI setup requests 310 with one or more LLI setup response frames, such as a first LLI setup response frame 302 and a second LLI setup response frame 304.

In various embodiments, the low latency indication mode can be negotiated through management frames between several types of entities, including between an AP or a soft AP and an associated STA, among multiple APs, between a group owner and peer STAs, or between an AP MLD and an associated non-AP MLD STA.

With respect to LLI request and response frames 312, 302, these frames can be defined as a set of new action frames for negotiation purposes. In one embodiment, a non-AP STA may send an LLI setup request frame 312 to the associated AP, and the AP MLD may respond with an LLI setup response frame 302. In one embodiment, the LLI setup request frame 312 may be indicated in the Robust Action field. Two values of the Robust Action field are used for LLI request and response frames 312, 302. For example, when the Robust Action field value equals 6, the value indicates an LLI setup request frame 312, and when the value equals 7, the value indicates an LLI setup response frame 302.

TABLE 1
Robust AV Streaming Robust Action Field

| Robust Action | |
|---|---|
| field value | Meaning |
| 6 | LLI Request |
| 7 | LLI Response |
| 8-255 | Reserved |

The information items that may be included in the LLI request frame are summarized in Table 2.

TABLE 2
Information Items in the LLI Negotiation Request Frames

| Information | |
|---|---|
| items | Introduction |
| LL Indication | A field may include the enablement of LLI feature. For |
| enablement | example, if the field is set to 1, the LLI is enabled. |
| LL Indication | A field may include the capability indication for LLI |
| capability | feature. For example, if the field is set to 1, the UHR STA |
| | may support the LLI. Otherwise, the UHR STA may not |
| | support this feature, or it is in other mode. |
| TID | A field may include the TID for negotiation. |
| AC | A field may include the AC for negotiation. The AC may |
| | be AC_VO for LLI as default. |
| User priority | A field may include the UP for negotiation. |
| SCS ID | A field in the negotiation request may include the SCSID. |
| QoS Char. | A field may include the QoS Char. for negotiation. |
| Service Start | A field may indicate the duration from the negotiation |
| Time | enabled to the time where the first LLI is transmitted and |
| Boundary | received by receiver. Otherwise, the LLI is timeout and |
| | renegotiation is needed. |
| Service End | A field may indicate the maximum duration from the first |
| Time | LLI is transmitted and received by receiver to the time |
| Boundary | boundary where the service is ended. For example, a few |
| | TXOP limits. |
| Maximum | A field may indicate the maximum duration from the |
| LL session | negotiation enabled to the end time of the service, for |
| timeout | example, a few TXOP limits. The disablement may |
| duration | happen before the timeout duration. Otherwise, the LL |
| | Session is disabled by the AP. |

The information items that may be included in the LLI response frame are summarized in Table 3.

TABLE 3
Information Items in the LLI Negotiation Response Frames

| Information | |
|---|---|
| items | Introduction |
| LL Indication | A field may include the enablement of LLI feature. For |
| enablement | example, if the field is set to 1, the LLI is enabled. |
| LL Indication | A field may include the capability indication for LLI |
| capability | feature. For example, if the field is set to 1, the UHR STA |
| | may support the LLI. Otherwise, the UHR STA may not |
| | support this feature, or it is in other mode. |
| TID | A field may include the TID for negotiation. A default |
| | value is reserved. |
| AC | A field may include the AC for negotiation. The AC may |
| | be AC_VO for LLI as default. |
| User priority | A field may include the UP for negotiation. A default |
| | value is reserved. |
| SCS ID | A field in the negotiation request may include the |
| | SCSID. A default value is reserved. |
| Status code | A field includes the Status such as AGREE, REJECT, |
| | CHANGE, UPDATE, etc. |
| QoS Char. | A field may include the QoS Char. for negotiation. |
| Service End | A field may indicate the maximum duration from the first |
| Time | LLI is transmitted and received by receiver to the time |
| Boundary | boundary where the service is ended. For example, a few |
| | TXOP limits. |
| Service Start | A field may indicate the duration from the negotiation |
| Time | enabled to the time where the first LLI is transmitted and |
| Boundary | received by receiver. Otherwise, the LLI is timeout and |
| | renegotiation is needed. |

An example of the embodiment for LLI negotiation request frames in LLI negotiation request frame exchange 400 is shown in FIG. 4 with an MBA frame 402 that includes an LLI indication that is transmitted by a non-AP STA during a maximum LL session timeout duration 410. The MBA frame 402 may end a service start time boundary 422 and starts a service end time boundary 424.

Although FIG. 3 illustrates one example of an LLI setup request and response frame exchange, various changes may be made to FIG. 3. For example, various components of FIG. 3 could be combined, further subdivided, or omitted and additional components could be added according to particular needs. Similarly, For example, various components of FIG. 4 could be combined, further subdivided, or omitted and additional components could be added according to particular needs.

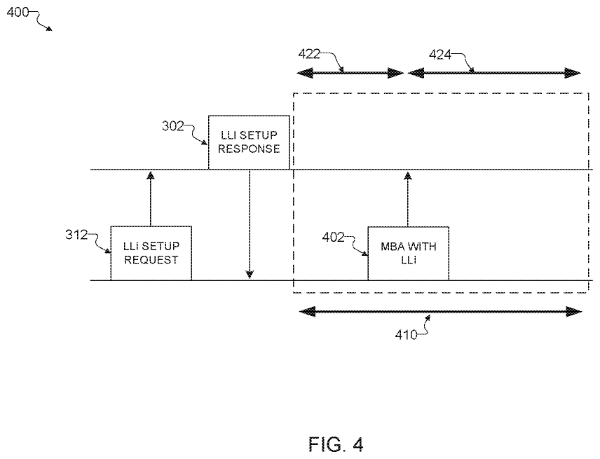

FIG. 5 illustrates an example LLI setup request and response frame exchange 500 according to embodiments of the present disclosure. For ease of explanation, the LLI setup request and response frame exchange 500 will be described as including one or more components of the wireless network 100 of FIG. 1, such as the non-AP STA 111; however, the LLI setup request and response frame exchange 500 could be implemented using any other suitable device or system. The embodiment of the LLI setup request and response frame exchange 500 shown in FIG. 5 is for illustration only. Other embodiments of the LLI setup request and response frame exchange 500 could be used without departing from the scope of this disclosure.

As shown in FIG. 5, the frame exchange 500 includes an LLI setup frame 502 that is configured to broadcast the capability of an AP MLD to support an LLI mode during one or more SCS streams with one or more non-AP STAs. Once the LLI setup frame 502 is broadcast during a negotiation phase 510, one or more non-AP STAs may respond with an LLI setup request frame, such as the first LLI setup request frame 312 and the second LLI setup request frame 322.

In other words, the AP MLD may transmit a management frame, such as the LLI setup frame 502, to probe or broadcast the capability of low latency interface support, along with other parameters set as defaults, such as the Service End Time Boundary. In response, non-AP STAs willing to negotiate a low latency interface session may provide a response to the frame.

The LLI setup frame 502 that the AP MLD may transmit can take the form of a management frame, for example, a Beacon frame, an association frame, or a probe response frame.

Although FIG. 5 illustrates one example of an LLI setup request and response frame exchange, various changes may be made to FIG. 5. For example, various components of FIG. 5 could be combined, further subdivided, or omitted and additional components could be added according to particular needs.

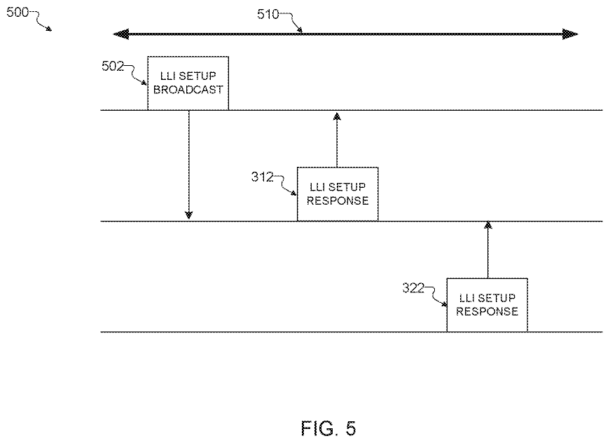

FIG. 6 illustrates an example frame exchange 600 on LLI with action policy according to embodiments of the present disclosure. For ease of explanation, the frame exchange 600 on LLI with action policy will be described as including one or more components of the wireless network 100 of FIG. 1, such as the non-AP STA 111; however, the frame exchange 600 on LLI with action policy could be implemented using any other suitable device or system. The embodiment of the frame exchange 600 on LLI with action policy shown in FIG. 6 is for illustration only. Other embodiments of the frame exchange 600 on LLI with action policy could be used without departing from the scope of this disclosure.

As shown in FIG. 6, the frame exchange 600 includes AP actions 602 that are taken after the MBA frame 402 is received by the AP MLD. Once the AP actions 602 are complete, a non-AP STA may transmit an LLI remove request frame 612 to terminate the LLI session to the AP MLD, which may respond with an LLI remove response frame 622.

In one embodiment, a non-AP STA seeking to enable or disable the LLI mode follows the update procedures, for example, by renegotiating using the LLI setup request and response frames 312, 302. The non-AP STA also uses the Request Type of the QoS characteristics element, where “ADD” is considered “Enablement” and “Delete” is considered “Disablement.” “Change” is considered unspecified or as a different LLI with different parameters.

The TXOP initiator or the LLI requesting STA sends an LLI teardown frame 612 to end an LL session 602, for example, the “Remove” or “Delete” type in the SCS frame, and the AP MLD responds with a confirmation frame 622. Alternatively, the TXOP responder or AP sends an LLI disablement frame by setting the LLI enablement field to disablement, for example, by setting the field equal to zero, and the non-AP STA responds with an ACK. The TXOP responder or AP also ends the LL session 602 when there is no low latency traffic (LLT) scheduled or no LLI received for a designated amount of time, such as an inactivity timeout.

The SCS negotiation frames also negotiate or indicate the traffic direction and corresponding response action types. Within the Direction field of the Control field of the SCS request frame, UL, P2P, and DL are indicated, and the request or suggested corresponding method is also included, for example, an Action Response field. The AR field is located in the reserved bits of the Control Info field of the SCS request frame or in the Presence Bitmap of Additional Parameters. An example of the Direction field and corresponding AR field is shown in Table 3.1.

TABLE 3.1
Action Response Request

| | Action | |
|---|---|---|
| Direction field | Response Field | Response action request field meaning |
| Direction is 0 | AR field is 0. | A field indicate that when there is an UL LLT, |
| for UP | | the TXOP holder may grant the TXOP holder |
| | | RDG if RDG/More PPDU is set to 1. |
| Direction is 0 | AR field is 1. | A field indicate that when there is an UL LLT, |
| for UP | | response action may be MU-RTS TXS mode |
| | | 1 from the TXOP holder. |
| Direction is 0 | AR field is 2. | A field indicate that when there is an UL LLT, |
| for UP | | response action may be TXOP sharing |
| | | request. |
| Direction is 1 | AR field is 0. | A field indicate that when there is a DL LLT, |
| for DL | | the TXOP holder may grant the TXOP holder |
| | | a RDG if RDG/More PPDU is set to 1. |
| Direction is 1 | AR field is 1. | A field indicate that when there is a DL LLT, |
| for DL | | TXOP responder may request a TXOP sharing |
| | | action to the TXOP holder. |
| Direction is 2 | AR field is 0. | A field indicate that when there is a P2P LLT, |
| for P2P | | response action request may be MU-RTS TXS |
| | | mode 2 from the TXOP holder. |
| Direction is 2 | AR field is 1. | A field indicate that when there is a P2P LLT, |
| for P2P | | response action request may be DUO from the |
| | | TXOP holder. |

The Action policy is a 1-bit decision, where a bit equal to 1 indicates that Action policy at the side of the AP MLD is assumed and required, and a value of zero indicates that Action Policy is unset or skipped, meaning that the response behavior is not required or assumed.

The DL Direction that the AP MLD transmits to the non-AP STA includes two use cases. In the first use case, when the AP MLD is the TXOP holder, LLI is transmitted from a non-AP STA TXOP responder, requesting the DL traffic of the AP MLD. The LLI is considered as an end of the PPDU returning the TXOP to the AP MLD or as an LLI requesting resumption of the DL. In the second use case, when the AP MLD is the TXOP responder, LLI is transmitted from the AP MLD requesting to send LLT to the non-AP STA.

Examples of other bits in the RAR field include, for example, no action or contending for the next TXOP. The action code on accept, reject, or type selection is also included in the Direction and AR fields. When the SCS response frame accepts the suggested or requested AR field, the response includes an Accept. If the peer STA does not accept the requested response action, the peer STA rejects with a reason indicating that the AR field requirements are not satisfied, such as ARfield_Unsatisfied. If the peer STA seeks to change the AR code, the peer STA responds with a Change and provides the corresponding response actions. The AR field is similarly located in the reserved bits of the Control Info field or in the Presence Bitmap of Additional Parameters.

As shown in FIG. 6, the non-AP STA starts the negotiation by sending an LLI setup request frame 312 with action policies requested from the TXOP holder or AP, and the AP MLD replies with an LLI setup response frame 302 containing an accept, reject, or change in the Response type field. The LL session 602 starts after the AP MLD accepts the LLI. The non-AP STA indicates to the AP MLD in the control frame when the LLT arrives in an MBA frame 402, and the AP MLD then takes the actions from the action policy as agreed in the negotiation stage. The non-AP STA or the AP MLD tears down or removes the request upon timeout or intentionally.

In another embodiment, the LLI enablement, disablement, or parameter updates are included in the LLI setup request and response frame 312, 302. The LLI setup request frame 312 includes an LLI enabled field, and when that field equals 1 and the LLI setup response frame 302 acknowledges the request, the LL session 602 becomes enabled. During enablement, the indication is transmitted over the MBA frame 402. The LLI setup request frame 312 may also take the form of the Link Reconfiguration ML frame, for example, Operation Mode and Parameter Updates Request, while the LLI setup response frame 302 is the Link Reconfiguration response or notify frame.

The LLI setup request frame 312 includes one or more parameter sets such as TID, SCSID, and QoS characteristics elements for enablement, or alternatively, just one parameter set such as TID, SCSID, and a single QoS characteristics element for enabling one set of QoS parameters at a time.

The LL session 602 supports one or more parameter sets. When multiple LLI request and response frames 312, 302 contain multiple parameters such as TIDs and QoS characteristics elements, each MBA LLI indicates one or more of the negotiated traffic streams. In another embodiment, the LLI indicates the buffered latency traffic outside of the parameter negotiation.

Although FIG. 6 illustrates one example of a frame exchange on LLI with action policy, various changes may be made to FIG. 6. For example, various components of FIG. 6 could be combined, further subdivided, or omitted and additional components could be added according to particular needs.

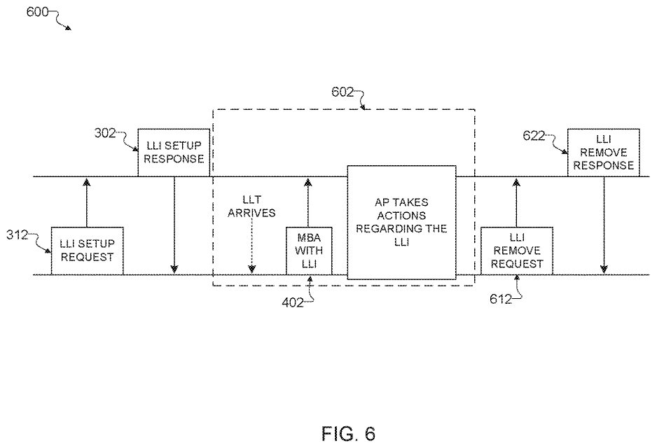

FIG. 7 illustrates an example LLI enablement field 700 supporting low latency indication negotiation according to embodiments of the present disclosure. For ease of explanation, the LLI enablement field 700 will be described as including one or more components of the wireless network 100 of FIG. 1, such as the non-AP STA 111; however, the LLI enablement field 700 could be implemented using any other suitable device or system. The embodiment of the LLI enablement field 700 shown in FIG. 7 is for illustration only. Other embodiments of the LLI enablement field 700 could be used without departing from the scope of this disclosure.

As shown in FIG. 7, the LLI enablement field 700 includes an LLI enablement field that may be included in the SCS negotiation frames, such as the SCS request frame and the SCS response frame.

In one embodiment, an LLI capability field may be included in the SCS negotiation frames. In another embodiment, the LLI enablement field may be included in the SCS Description element. In an example variant of this embodiment, the LLI enablement field may be included in the QoS characteristics element.

In one embodiment, the LLI enablement field may be included in the Control Info field of the QoS characteristics element. For example, the LLI enablement field may be included in a reserved bit of the Control Info field. The LLI enablement field may also be included in one or more bits of the Presence Bitmap of Additional Parameters of the Control Info field.

Although FIG. 7 illustrates one example of an LLI enablement field supporting low latency indication negotiation, various changes may be made to FIG. 7. For example, various components of FIG. 7 could be combined, further subdivided, or omitted and additional components could be added according to particular needs.

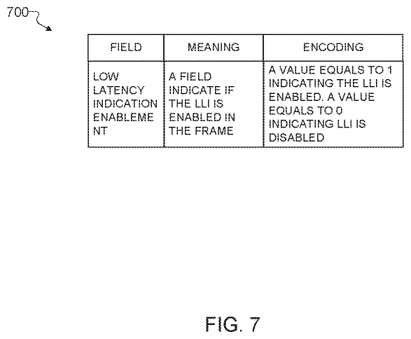

FIGS. 8A-8E illustrate example LLI enablement formats 800A-800E according to embodiments of the present disclosure. For ease of explanation, the LLI enablement formats 800A-800E will be described as including one or more components of the wireless network 100 of FIG. 1, such as the non-AP STA 111; however, the LLI enablement formats 800A-800E could be implemented using any other suitable device or system. The embodiment of the LLI enablement formats 800A-800E shown in FIGS. 8A-8E is for illustration only. Other embodiments of the LLI enablement formats 800A-800E could be used without departing from the scope of this disclosure.

As shown in FIG. 8A, a control field 800A of a low latency QoS characteristics element includes a reserved field for Low Latency Indication (LLI) in the Element ID of the SCS Descriptor element or the QoS characteristics element. When the Element ID is set as the Low Latency Indication, the QoS characteristics element may be set with specified values, which may be referred to as the QoS characteristics LL element. The QoS characteristics LL element is an element in which some of the fields of the QoS characteristics element may be set to zero, designated as optional, or left specified or unspecified. The information that may be considered unspecified is discussed below.

TABLE 4
Element ID

| | | Element ID | |
|---|---|---|---|
| Element | Element ID | Extension | Extensible |
| Low latency | A reserved | A reserved | A reserved |
| indication | value | value | value |

In one embodiment, the Element is the QoS characteristics element, and the Element ID Extension is present and reserved for a specific value in which the subelement is reserved for LLI. When the Element ID and the Element ID Extension are set for LLI, the parameters in the SCS Descriptor are unspecified when LLI enablement is set to 1, even if some of the parameters are set. For example, the TID, LinkID, delay bounds, data rate, and similar parameters may be unspecified when LLI is set to 1. Similarly, the TID, LinkID, delay bounds, data rate, and similar parameters may be unspecified when LLI is set to 1 and the Element ID and Element ID Extension are reserved for LLI.

In one embodiment, when LLI is enabled, for example when the Element ID is set to the Low Latency Indication element, or the LLI enablement field is set to 1, or the LLI request field is set to 1, one or more of the following parameters in the QoS characteristics LL element may be considered with respect to the QoS Characteristics Control field.

Regarding the Control field, the Direction in the control field is set to 0 for uplink (UL) when negotiating with an AP and requesting UL LL transmission. The Direction in the control field is set to 2 for peer-to-peer transmission when negotiating with an AP and requesting P2P LL transmission, and this setting may also indicate negotiation among APs or AP MLDs. The Direction in the control field may be set to 3 for multiple directions or any directions, for example UL or P2P direct link direction, which may not be able to be specified during negotiation. The Direction field may be unspecified if the direction of the traffic is unknown or if LLI is enabled.

With respect to the Minimum Service Interval, when LLI is enabled and the Direction subfield is set to 0, the Minimum Service Interval may be set to a specific value, a unique value, or an unspecified value, for example a value of 0, between the start of two consecutive SPs that are allocated to the non-AP STA for LL UL frame exchange when LLI is indicated in the SPs. When LLI is enabled and the Direction subfield is set to 2, the Minimum Service Interval may be set to a specific value, a unique value, or an unspecified value, for example a value of 0, between the start of two consecutive SPs that are allocated to the non-AP STA for direct link frame exchange when LLI is indicated in the SPs. When LLI is enabled and the Direction subfield is unspecified, the Minimum Service Interval may be set to a specific value, a unique value, or an unspecified value, for example a value of 0, between the start of two consecutive SPs that are allocated to the non-AP STA for direct link frame exchange when LLI is indicated in the SPs. When LLI is enabled, the value can be specified for the request SCS or an ongoing SCS with an LLI request.

With respect to the Maximum Service Interval, when LLI is enabled and the Direction subfield is set to 0, the Maximum Service Interval may be set to a specific value, a unique value, or an unspecified value, for example a value of 0, between the start of two consecutive SPs that are allocated to the non-AP STA for LL UL frame exchange when LLI is indicated in the SPs. When LLI is enabled and the Direction subfield is set to 2, the Maximum Service Interval may be set to a specific value, a unique value, or an unspecified value, for example a value of 0, between the start of two consecutive SPs that are allocated to the non-AP STA for direct link frame exchange when LLI is indicated in the SPs. When LLI is enabled and the Direction subfield is unspecified, the Minimum Service Interval may be set to a specific value, a unique value, or an unspecified value, for example a value of 0, between the start of two consecutive SPs that are allocated to the non-AP STA for direct link frame exchange when LLI is indicated in the SPs. Aperiodic traffic can be indicated when the Minimum Service Interval field and the Maximum Service Interval field are set to the value 0, NAN, or a specific unsigned integer, and the LL enablement field is enabled or set to 1. When LLI is enabled or set to 1, the eligible LLI session duration for aperiodic traffic that can be indicated using the LLI feature may be set through the Minimum Service Interval field and the Maximum Service Interval field to specify the valid SP duration. For example, the minimum service interval can be set to 5 ms and the maximum service interval can be set to 10 ms, meaning a duration of 5 ms to 10 ms is set for the LLI session to indicate the traffic. For any excluded duration outside of the LLI enabled session, the LLI feature may not be available for use. When LLI is enabled, the value can be specified for the request SCS or an ongoing SCS with an LLI request.

With respect to the Minimum Data Rate field, if LLI is enabled and the Direction subfield is set to 0 (Uplink), 1 (Downlink), or 2 (Direct link), a value of 0 in the minimum data rate field indicates that this parameter is unspecified. When LLI is enabled, the value can be specified for the request SCS or an ongoing SCS with an LLI request.

With respect to the Delay Bound field, when LLI is enabled and the Direction subfield is set to 0 (Uplink) or 2 (Direct link), a value of 0 indicates that this parameter is unspecified. When LLI is enabled and the Direction subfield is set to 0 (Uplink) or 2 (Direct link), the value can be specified for the SCS or an ongoing SCS with an LLI request.

With respect to the Maximum MSDU Size field, when LLI is enabled, a value of 0 indicates that this parameter is unspecified or optional. When LLI is enabled, the value can be specified for the request or an ongoing SCS with an LLI request.

With respect to the Service Start Time field, when LLI is enabled, a value of 0 indicates that this parameter is unspecified or optional. When LLI is enabled, the value can be specified for the request SCS or an ongoing SCS with an LLI request.

With respect to the Service Start Time LinkID, when LLI is enabled, a value of 0 indicates that this parameter is unspecified or optional. When LLI is enabled, the value can be specified for the request SCS or an ongoing SCS with an LLI request.

With respect to the Mean Data Rate field, when LLI is enabled, a value of 0 indicates that this parameter is unspecified or optional. When LLI is enabled, the value can be specified for the request SCS or an ongoing SCS with an LLI request.

With respect to the Delay Bounded Burst Size field, when LLI is enabled, a value of 0 indicates that this parameter is unspecified or optional. When LLI is enabled, the value can be specified for the request SCS or an ongoing SCS with an LLI request.

With respect to the MSDU Lifetime field, when LLI is enabled, a value of 0 indicates that this parameter is unspecified or optional. When LLI is enabled, the value can be specified for the request SCS or an ongoing SCS with an LLI request.

With respect to the MSDU Delivery Info field, when LLI is enabled, a value of 0 indicates that this parameter is unspecified or optional. When LLI is enabled, the value can be specified for the request SCS or an ongoing SCS with an LLI request.

In one embodiment, when LLI is enabled, the AP MLD may not need to schedule transmission according to the LL QoS characteristics element. In another embodiment, the AP MLD may consider the LL QoS characteristics element if there is a specified value or request for the LL QoS characteristics element.

When the enablement field equals 1 and is located after the SCSID and Request Type, for example in the Control Info field of the QoS characteristics element, the SCSID may be unspecified. When the enablement field equals 1 and is located at the end of the Control Info field, fields such as the Direction, TID, UP, LinkID, and similar parameters may be unspecified. When the enablement field equals 1 and is located at the end of the Control Info field, the fields such as the Direction, TID, UP, LinkID, and similar parameters may be unspecified during LLI negotiation. When the enablement field equals 1, the Direction field may be zero for UL traffic. When the enablement field equals 1, the Direction field may only be zero for UL traffic.

The Request Type “ADD” may be considered as “Enablement,” the Request Type “Delete” may be considered as “Disablement,” and the Request Type “Change” may be considered as unspecified or as a different LLI with different parameters.

According to one embodiment, the LLI enablement field may be included in the reserved bit of the Intra-Access Priority element field as shown in the intra-access priority element field 800B of FIG. 8B.

Regarding the relationship between SCS and SCS for LLI, when the SCS of LLI negotiation is being set up, an 11be SCS can still be set up, and conflicts may exist in both cases. In one embodiment, if the traffic of the 11be SCS negotiation includes the same traffic as the 11bn SCS LLI, the non-AP STA may use an SCS request frame or a D-SCS frame instead of LLI. The STA may also use LLI if no re-negotiation is preferred. In one embodiment, if the traffic of the 11be SCS negotiation is negotiated before the LLI-SCS, then an ongoing SCS with a specific SCSID, TID, UP, and similar parameters is specified. The LLI-SCS request frame may choose to maintain one or more of these parameters and enable LLI, which may relate to or belong to the ongoing SCSID. In one embodiment, if the traffic of the 11be SCS negotiation is negotiated after the LLI-SCS, then the SCS negotiation may be considered to send both an SCS request and LLI in case the SCS request frame is rejected. There are several scenarios regarding the relationship between an LLI session and an SCS session.

TABLE 5
LLI Session and SCS Session Scenarios

| | LLI & SCS session | |
|---|---|---|
| | relationship | Parameter settings. |
| Case | LLI starts and ends fully | Parameters such as SCSID, TID, UP can be set |
| 1 | before or after SCS | independently. |
| | session. | |
| Case | LLI starts before SCS | A conflict if setting parameters for LLI and SCS |
| 2 | session starts, end after | request may have different sets of parameters. E.g., |
| | SCS session starts and | SCSID for LLI is A, then SCSID or UP for SCS |
| | before SCS session ends. | session is B. The conflict may result in a wash over |
| | | of LLI's parameters. And different traffic from SCS |
| | | settings may not be treated as LLI. |
| Case | LLI session duration is | The parameters are all SCS, only the parameters of |
| 3 | covered by SCS session. | LLI session that aligned with SCS may be |
| | | considered and treated. |
| Case | LLI starts after SCS | The rest of the LLI session after SCS session ends |
| 4 | session starts and before | may have more freedom while it may be set to be |
| | SCS session ends. LLI | aligned with SCS session for the overlapped |
| | end after the SCS session | duration. |
| | ends. | |
| Case | LLI session may cover | The overlapped duration may have a different |
| 5 | the whole SCS session. | parameter compared with LLI session which then |
| | | results in a different parameter of LLI. |
| Case | SCS session may change | The LLI may change accordingly or maintain the |
| 6 | after the LLI session | ongoing or higher traffic. |
| | starts. | |

Regarding SCS and LLI parameter settings, in one embodiment, the SCSID and other parameters such as TID, UP, and similar fields in the LLI-SCS request and LLI-SCS response frame may be set as default or unspecified until an SCSID is specified and updated. The SCSID is updated when an SCS request and response frame is exchanged and accepted or updated. In one embodiment, LLI can indicate the LL traffic that is aligned with the ongoing traffic access category (AC) or a higher AC. In one embodiment, LLI may be tied or untied to the SCSID. If LLI is untied from the SCSID, the SCSID may be set as unspecified or a default value.

The LLI-SCS may include an LLI Enabled or LLI request field, for example by using the Request Type field as the LLI enablement field as shown in the SCS frame format 800C of FIG. 8C. In one embodiment, the request field of the SCS Request Type definitions or SCS-LLI Request Type definitions may be designed as shown in Table 6.

TABLE 6
SCS Request Type Definitions

| Name | Value |
|---|---|
| Add | 0 |
| Remove | 1 |
| Change | 2 |
| LLI request | 3 |
| Reserved | 4-255 |

The “LLI request” or “LLI enabled” designation may be a new value of the SCS Request Type. In one embodiment, the LLI enablement may be positioned at the beginning of the Control Info field of the QoS characteristics element. Examples of this configuration are shown in a Control Info field 800D and the Control Info field 800E of FIGS. 8D and 8E, respectively.

In one embodiment, the LL session 602 may support one or more parameter sets during the LLI session. If there are multiple SCS request and response frames with an LLI Request, each MBA LLI may indicate one or more of the traffic flows that have been negotiated in the SCS request and response frame. The scheduling prioritization of the traffic is left to AP implementation. In one embodiment, if a non-AP STA has multiple SCS streams with different LLI Request values and these streams may be mapped to the same TID, the LLI may indicate the traffic, and the non-AP STA may schedule the urgent traffic based on local implementation. In another embodiment, the LLI may include the latest parameter sets, and the AP MLD may update the information based on the latest SCS with an LLI request. In another embodiment, the LLI may indicate the buffered latency traffic outside of the parameter negotiation.

Although FIGS. 8A-8E illustrate examples of LLI enablement formats, various changes may be made to FIGS. 8A-8E. For example, various components of FIGS. 8A-8E could be combined, further subdivided, or omitted and additional components could be added according to particular needs.

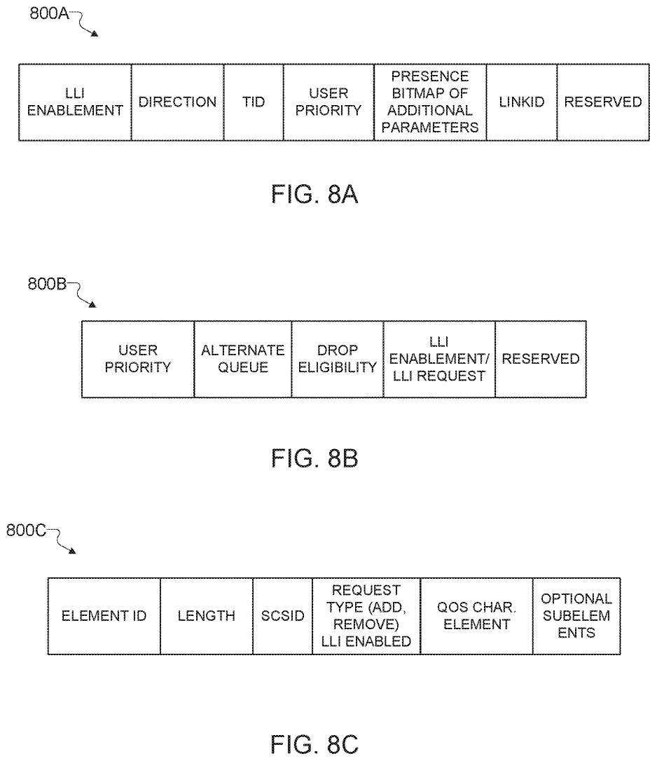

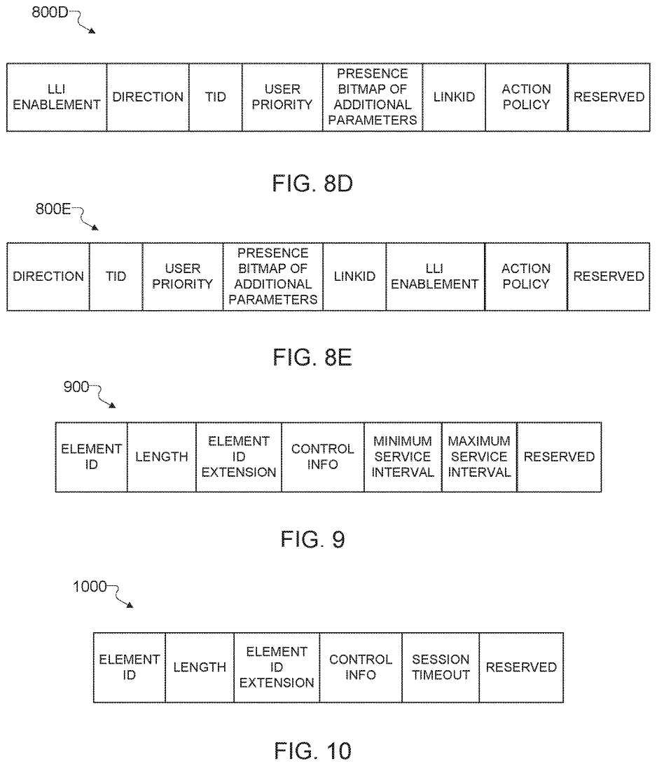

FIG. 9 illustrates an example QoS characteristics element format 900 supporting low latency indication negotiation according to embodiments of the present disclosure. FIG. 10 illustrates an example the QoS characteristics element 1000 supporting low latency indication negotiation according to embodiments of the present disclosure. For ease of explanation, the QoS characteristics element 900 will be described as including one or more components of the wireless network 100 of FIG. 1, such as the non-AP STA 111; however, the QoS characteristics element 900 could be implemented using any other suitable device or system. The embodiment of the QoS characteristics element 900 shown in FIG. 9 is for illustration only. Other embodiments of the QoS characteristics element 900 could be used without departing from the scope of this disclosure.

As shown in FIG. 9, the QoS characteristics element 900 includes one or more information items in Table 2 and Table 3 and may be considered as a new QoS Characteristic Element with a Low Latency Interface (LLI) enablement field, thereby enabling a lightweight SCS request and response mechanism.

In one embodiment, when LLI is enabled, the LL QoS characteristics element may contain one or more fields, an example of which is shown in FIG. 6. The LL session 602 timeout field indicates the maximum duration or service period of the feature lifetime, as shown in the QoS characteristics element format 1000 in FIG. 10.

In another embodiment, the LL session duration may not be specified, and the LLI may be enabled immediately following the negotiation. A new LL session 602 with different parameters may be changed or updated through re-negotiation using new SCS frame exchanges. An LL session 602 may be terminated by disabling the LLI field or by setting the LLI enablement to zero. According to one embodiment, the AR field may also be considered in the Control Info field of the LL QoS characteristics element.

Regarding a UHR Link Reconfiguration Request frame, according to one embodiment, the LLI enablement can be included in the Link Reconfiguration Request frame. In a variant of this embodiment, the LLI enablement may be included as one of the Type fields, as shown in FIG. 5. In one embodiment, the Reconfiguration Multi-Link element may include UHR Capabilities and Operations where features such as LLI and PEDCA may be included for enablement or disablement. One or more of these features may be enabled or disabled using the Link Reconfiguration Request frame by setting the corresponding subfield in the Type field. Additionally, according to one embodiment, the Action Policy can be included in the Link Reconfiguration Request frame.

With respect to a UHR Link Reconfiguration Notify frame, according to one embodiment, the LLI enablement feedback or acknowledgment can be included in the Link Reconfiguration Notify frame. In one embodiment, the Action Policy can also be included in the Link Reconfiguration Notify frame, and parameter updates can likewise be included in the Link Reconfiguration Notify frame.

Regarding operating mode and parameter updates, in one embodiment, when the LLI enablement in the Link Reconfiguration Request frame on the corresponding link or links is set to 1 as enabled, the OMP request may carry the fields related to LLI. The OMP request frame may include the information items discussed above, such as those in Table 3 and FIG. 5. For example, the Action Policy, SCSID, UP, TID, and QoS characteristics element may be included in the OMP request frame.

In one embodiment, the OMP response frame may include a response to the information items. For example, if the AP MLD accepts the LLI with the Action Policy set to 1, the AP MLD may respond to the OMP request with an OMP response indicating acceptance. When the AP MLD rejects the LLI with the Action Policy set to 1, the AP MLD may respond with a rejection code or a modification of the suggested Action Policy. In one embodiment, the Action Policy, SCSID, TID, and QoS characteristics element may be included in the OMP response frame. Additionally, the OMP request frame and the OMP response frame may update parameters related to the Action Policy, SCSID, TID, and QoS characteristics element.

In one embodiment, the non-AP STA may send an acknowledgment to the OMP response frame to confirm the requested parameters, the updated parameters, or the suggestions. In one embodiment, the non-AP STA affiliated with a non-AP MLD may send an acknowledgment to the OMP response frame on the corresponding link or links to confirm the requested parameters, the updated parameters, or the suggestions.

With respect to multiple LLI negotiations, for multiple LLI QoS characteristics element negotiations, a non-AP STA may negotiate with an AP one QoS characteristics element at a time. In another embodiment, the non-AP STA may negotiate with more QoS characteristics elements in a single SCS frame.

Regarding Dynamic SCS request and response frames, in one embodiment, an LLI negotiation may use D-SCS negotiation frames. In one embodiment, an LLI negotiation may specify the Dynamic QoS Profile.

With respect to variations of RDG, a combination of unused AC Constraint and RDG/More PPDU may be used for initiating the LL session 602. For example, when AC Constraint equals 1 and RDG/More PPDU equals 1, an LL session 602 is started.

Regarding LL support TWT requesting and responding frames, in one embodiment, an LLI enablement may be included in the TWT requesting and responding frames. The control field and the AR field may be included in the LLI TWT requesting and responding frames.

Although FIG. 9 illustrates one example of a QoS characteristics element format supporting low latency indication negotiation, various changes may be made to FIG. 9. For example, various components of FIG. 9 could be combined, further subdivided, or omitted and additional components could be added according to particular needs. Similarly, various components of FIG. 10 could be combined, further subdivided, or omitted and additional components could be added according to particular needs.

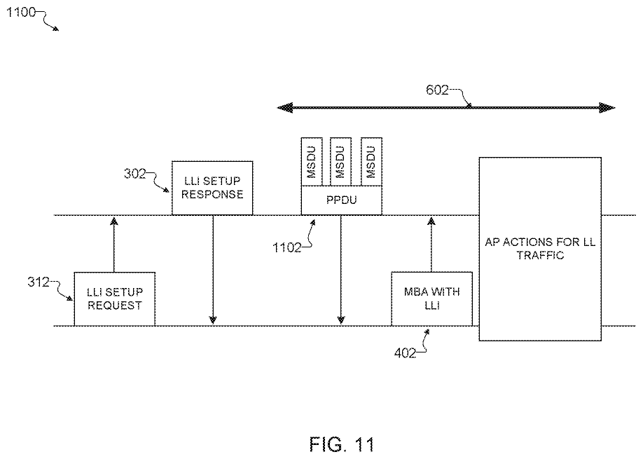

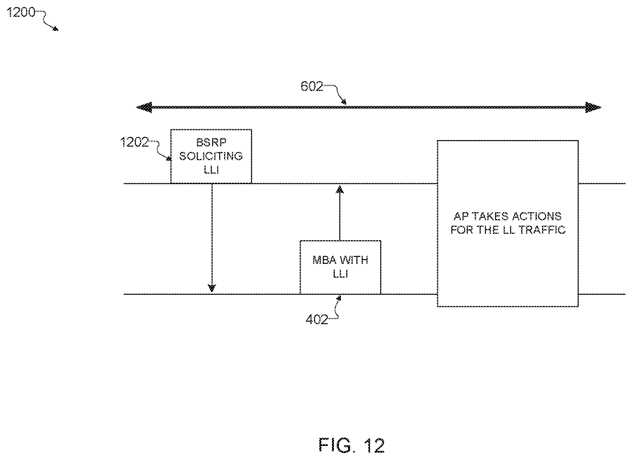

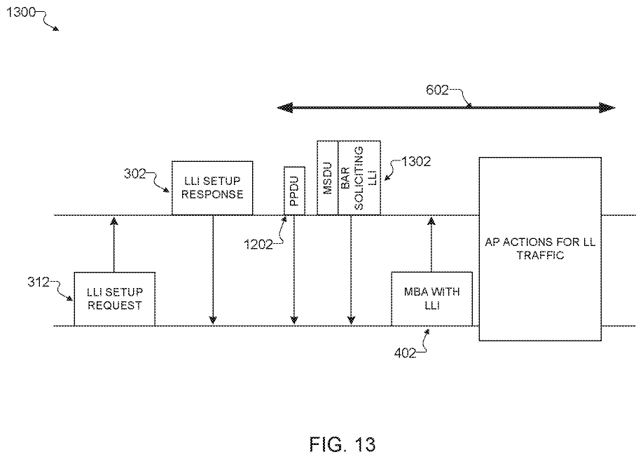

FIG. 11 illustrates an example frame exchange 1100 using a physical layer protocol data unit (PPDU) to solicit LLI supporting low latency indication negotiation according to embodiments of the present disclosure. FIG. 12 illustrates an example frame exchange 1200 using a buffer status report poll (BSRP) to solicit LLI supporting low latency indication negotiation according to embodiments of the present disclosure. FIG. 13 illustrates an example frame exchange 1300 using a block acknowledgment request (BAR) to solicit LLI supporting low latency indication negotiation according to embodiments of the present disclosure. For ease of explanation, the frame exchange 1100 will be described as including one or more components of the wireless network 100 of FIG. 1, such as the non-AP STA 111; however, the frame exchange 1100 could be implemented using any other suitable device or system. The embodiment of the frame exchange 1100 shown in FIG. 11 is for illustration only. Other embodiments of the frame exchange 1100 could be used without departing from the scope of this disclosure.

As shown in FIG. 11, the frame exchange 1100 includes a data PPDU 1102 that is transmitted by the AP MLD during the LL session 410.

In one embodiment, a non-AP STA that receives a data PPDU 1102, such as a MAC protocol data unit (MPDU), soliciting an immediate response, such as one containing Ack Policy set to Block Ack, may respond with a Multi-STA BlockAck frame. The Multi-STA BlockAck frame may include one or more combinations of the Traditional Block Ack Bitmap, LLI feedback in the Feedback field, and DUO Feedback in the Feedback field. When LLI feedback and DUO Feedback both appear, the TXOP holder may choose to terminate the TXOP. The TXOP holder may also share the TXOP at a specified time indicated in the Target Time and Unavailability Time duration.

Alternatively, as shown in FIG. 12, a BSRP frame 1202 may be used for soliciting the LLI. When the AP MLD device, AP MLD, or a soft AP device serves as the TXOP holder and the non-AP STA serves as the TXOP responder, the AP MLD may solicit an LLI by transmitting a non-HT duplicated PPDU. In this case, the BSRP Trigger may use GI3, and the non-AP STA may send a non-HT PPDU containing the LLI information. The AID12 in User Info of the BSRP may be set to the non-AP STA. Additionally, as shown in FIG. 13, a BAR embedded in an MSDU 1302 may include a BAR configured to solicit LLI in the non-HT PPDU.

Although FIG. 11 illustrates one example of a frame exchange using a PPDU to solicit LLI supporting low latency indication negotiation, various changes may be made to FIG. 11. For example, various components of FIG. 11 could be combined, further subdivided, or omitted and additional components could be added according to particular needs. Similarly, various components of FIGS. 12 and 13 could be combined, further subdivided, or omitted and additional components could be added according to particular needs.

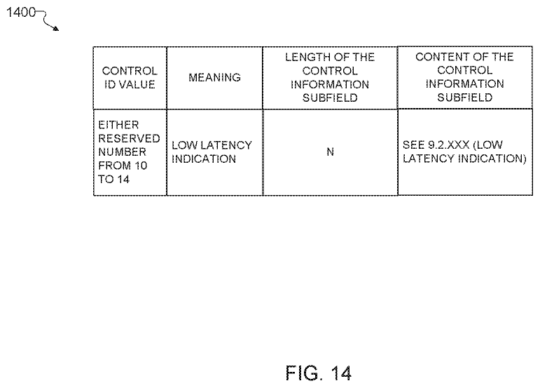

FIG. 14 illustrates an example A-Control field 1400 supporting low latency indication negotiation according to embodiments of the present disclosure. For ease of explanation, the A-Control field 1400 will be described as including one or more components of the wireless network 100 of FIG. 1, such as the non-AP STA 111; however, the A-Control field 1400 could be implemented using any other suitable device or system. The embodiment of the A-Control field 1400 shown in FIG. 14 is for illustration only. Other embodiments of the A-Control field 1400 could be used without departing from the scope of this disclosure.

As shown in FIG. 14, the A-Control field 1400 includes an LLI indication. A new Control ID subfield value may indicate the Dynamic QoS Profile.

According to one embodiment involving a variant of existing A-control fields, the individual addressed BSRP trigger frame may be used for soliciting the LLI feedbacks such as switch indication and D-SCS response. The trigger frame may set the GI and HE/EHT/UHR-TLF Type subfield of the Common Info field to 3. The PPDU sent in response to the BSRP Trigger frame is then a non-HT (duplicate) PPDU that contains a Multi-STA BlockAck frame.

In one embodiment, a Multi-STA BA frame may include both Block Ack Bitmap and Feedback information if the preceding PPDU includes QoS Data frame or frames that solicit an immediate response and the non-AP STA is operating in the LLI session or mode that allows inclusion of feedback information.

In one embodiment, a BSRP trigger frame may include a special User Info, Feedback information, or a UHR User Info field and other information if the trigger frame is soliciting both non-HT PPDU and the acknowledgement with the Feedback information and the non-AP STA is operating in the LLI session or mode that allows the inclusion of the feedback information.

The indication of the QoS Profile field and low latency indication is carried in the Common Info field of the BSRP Trigger frame.

According to one embodiment involving BAR retrieval of LL information, an implicit BAR may retrieve LL information in the RD frames sent from the RD initiator.

With respect to un-soliciting LLI indication containers, and specifically BSRP LL information, if a non-AP STA is the TXOP holder and the AP MLD is the TXOP responder, the non-AP STA may transmit a non-TB PPDU such as BSRP in an un-soliciting manner to indicate the LLI.

The LLI may be included in the User Info field of the BSRP. For example, a Special User Info field containing the indication information, such as DUO, Low latency, dynamic QoS, or enhanced BSR, may include the information of the legacy BSRP or the information in Table 7.

TABLE 7
User Info Field of BSRP with LLI

| Information | |
|---|---|
| items | Introduction |
| LL Indication | A field may include the enablement of LLI feature. For |
| enablement | example, if the field is set to 1, the LLI is enabled. |
| LL Indication | A field may include the capability indication for LLI |
| capability | feature. For example, if the field is set to 1, the UHR STA |
| | may support the LLI. Otherwise, the UHR STA may not |
| | support this feature, or it is in other mode. |
| TID | A field may include the TID for negotiation. |
| AC | A field may include the AC for negotiation. |
| User priority | A field may include the UP for negotiation. |
| SCS ID | A field in the negotiation request may include the SCSID. |

In one embodiment, the AID of the User Info field may be set as the TXOP responder address or as the AID carrying the buffered LL. The AID of the User Info field may also be set as the TXOP holder address.

On receiving the low latency indication in the control response frame, the TXOP holder may consider the low latency indication in determining subsequent actions within the current TXOP or subsequent TXOPs. For example, when the feedback of the LLI is reversed direction, the TXOP holder may initiate a TB-PPDU to solicit the UL traffic from the TXOP responder. In another embodiment, the TXOP holder may set the RDG/More PPDU field to 1 for the next PPDU, and the TXOP responder may use RDG to transmit the UL traffic.

Although FIG. 14 illustrates one example of an A-Control field supporting low latency indication negotiation, various changes may be made to FIG. 14. For example, various components of FIG. 14 could be combined, further subdivided, or omitted and additional components could be added according to particular needs.

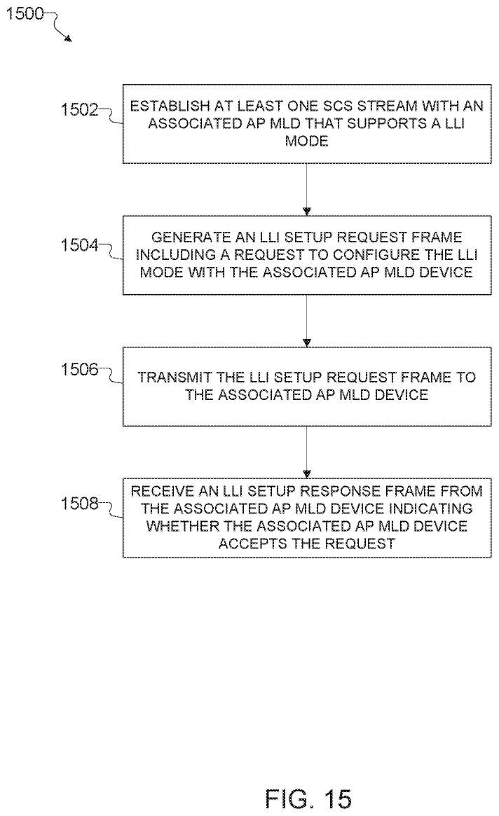

FIG. 15 illustrates an example method 1500 for low latency indication negotiation performed by a non-AP STA according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of low latency indication negotiation performed by a non-AP STA could be used without departing from the scope of this disclosure.

As shown in FIG. 15, at least one SCS stream is established with an associated AP MLD that supports an LLI mode at step 1502. For example, the non-AP STA and the AP MLD may engage in an SCS frame exchange where the non-AP STA transmits an SCS request frame and the AP MLD responds with an SCS response frame to establish at least one SCS stream with the non-AP STA.

An LLI setup request frame is generated including a request to configure the LLI mode with the associated AP MLD device at step 1504. For example, the non-AP STA may generate an LLI setup request frame 312 requesting to configure the LLI mode with the associated AP MLD device. The LLI setup request frame may be a management frame having an LLI Requested subfield set to 1.

The LLI setup request frame is transmitted to the associated AP MLD device at step 1506. For example, the non-AP STA may transmit the LLI setup request frame 312 to the AP MLD.

An LLI setup response frame is received from the associated AP MLD device indicating whether the associated AP MLD device accepts the request at step 1508. For example, the non-AP STA may receive an LLI setup response frame 302 from the AP MLD indicating whether the request to configure an LLI mode is accepted.

Although FIG. 15 illustrates one example method for low latency indication negotiation performed by a non-AP STA, various changes may be made to FIG. 15. For example, while shown as a series of steps, various steps in FIG. 15 could overlap, occur in parallel, occur in a different order, or occur any number of times.

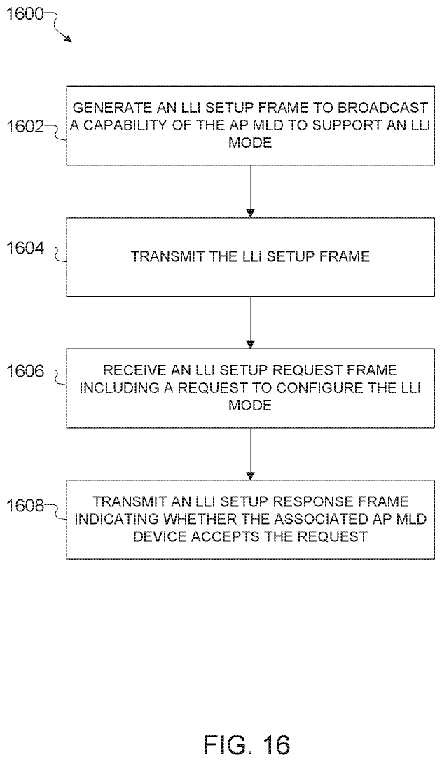

FIG. 16 illustrates an example method 1600 for low latency indication negotiation performed by an AP MLD according to embodiments of the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of low latency indication negotiation performed by an AP MLD could be used without departing from the scope of this disclosure.

As shown in FIG. 16, an LLI setup frame is generated to broadcast a capability of the AP MLD to support an LLI mode at step 1602. For example, the AP MLD may generate an LLI setup frame 502 having an indication of the capability of the AP MLD to support an LLI mode. The AP MLD then broadcasts or transmits the LLI setup frame at step 1604.

An LLI setup request frame is received from a non-AP STA that includes a request to configure the LLI mode at step 1606. For example, the non-AP STA may generate an LLI setup request frame 312 requesting to configure the LLI mode with the associated AP MLD device. The LLI setup request frame may be a management frame having an LLI Requested subfield set to 1. the non-AP STA may transmit the LLI setup request frame 312 to the AP MLD.

An LLI setup response frame is transmitted from the associated AP MLD device indicating whether the associated AP MLD device accepts the request at step 1608. For example, the AP MLD, upon receiving the LLI setup request frame 312, may generate and transmit an LLI setup response frame 302 indicating acceptance or rejection of the request to configure an LLI mode.

Although FIG. 16 illustrates one example method for low latency indication negotiation performed by an AP MLD, various changes may be made to FIG. 16. For example, while shown as a series of steps, various steps in FIG. 16 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a non-access point (AP) station (STA), the method comprising:
establishing at least one stream classification service (SCS) stream with an associated AP multi-link device (MLD) that supports a low latency indication (LLI) mode;
generating an LLI setup request frame comprising a request to configure the LLI mode with the associated AP MLD device, wherein the LLI setup request frame is a management frame having an LLI Requested subfield set to 1;
transmitting the LLI setup request frame to the associated AP MLD device; and
receiving an LLI setup response frame from the associated AP MLD device indicating whether the associated AP MLD device accepts the request.

2. The method of claim 1, wherein the LLI setup request frame comprises a stream classification service (SCS) identifier (ID) and a quality of service (QoS) characteristics element having the LLI Requested subfield.

3. The method of claim 2, wherein the LLI setup response frame further comprises an SCS ID, a QoS characteristics element, and a status code field.

4. The method of claim 1, wherein the LLI setup request frame is a Link Reconfiguration ML frame or an Operation Mode and Parameters (OMP) frame.

5. The method of claim 4, wherein the LLI setup request frame includes one or more parameter sets, wherein the one or more parameter sets include at least one of a QoS or an SCS ID to establish a use of the LLI mode using OMP frames.

6. The method of claim 1, wherein:
the LLI setup request frame is an SCS request frame; and
the SCS request frame includes in an SCS description element or a QoS characteristics element with an LLI Requested subfield equal to 1, wherein the LLI Requested subfield set to 1 indicates that the LLI mode is requested of the SCS streams described by a SCS description element or a QoS characteristics element and the LLI Requested subfield is set to 0 otherwise.

7. The method of claim 1, wherein:
the LLI setup request frame includes a maximum service interval field; and
when the LLI mode is enabled, if a direction subfield is set to 0, the maximum service interval field contains an unsigned integer that specifies a maximum interval between a start of two consecutive service periods (SPs) that are allocated to the non-AP STA for uplink (UL) frame exchanges and the maximum service interval field has a value of 0 when the LLI Requested subfield in a Control Info field is set to 1.

8. The method of claim 1, wherein:
the LLI setup request frame includes a minimum service interval field; and
when an LLI mode is enabled, if a direction subfield is set to 0, the minimum service interval field contains an unsigned integer that specifies a minimum interval between a start of two consecutive SPs that are allocated to the non-AP STA for uplink (UL) frame exchanges and the minimum service interval field has a value 0 when the LLI Requested subfield in a Control Info field is set to 1.

9. The method of claim 1, wherein:
the LLI Requested subfield is positioned in a Control Info field of a QoS characteristics element;
if there are multiple SCS request and response frames with an LLI Requested subfield indicating a use of the LLI mode is being requested, the LLI setup request frame indicates the use of the LLI mode for one or more of traffic that has been negotiated in one or more SCS request and response frames;
the non-AP STA negotiates one or more SCS with an LLI Requested field set to 1; and
the non-AP STA negotiates with more QoS characteristics elements in one SCS frame.

10. The method of claim 1, further comprising:
receiving a data physical layer protocol data unit (PPDU) including a MAC protocol data unit (MPDU) that solicits an immediate response; and
responding using a multi-STA BlockAck frame, which includes one or more of an LLI feedback in a feedback field, a DUO feedback in the feedback field, or a combination thereof.

11. The method of claim 1, wherein:
the associated AP MLD is a transmit opportunity (TXOP) holder;
the non-AP STA is a TXOP responder; and
the method further comprises:
receiving, from the associated AP MLD, a non-high throughput (HT) duplicated PPDU as a buffer status report poll (BSRP) trigger frame to solicit an LLI, wherein the BSRP trigger frame uses GI3 and is either an individually addressed BSRP trigger frame or a group addressed BSRP trigger frame; and
transmitting a non-HT PPDU with the LLI information, wherein an association identifier (AID12) in a User Info field of the BSRP is set to the non-AP STA.

12. A method performed by an access point (AP) multi-link device (MLD), the method comprising:
generating an LLI setup frame to broadcast a capability of the AP MLD to support an LLI mode, wherein the LLI setup frame is a management frame;
transmitting the LLI setup frame;
receiving, from a non-AP STA, an LLI setup request frame comprising a request to configure the LLI mode, wherein the LLI setup request frame is a management frame having an LLI Requested subfield set to 1; and
transmitting, to the non AP STA, an LLI setup response frame indicating whether the AP MLD device accepts the request.

13. The method of claim 12, wherein the LLI setup request frame comprises a stream classification service (SCS) identifier (ID) and a quality of service (QoS) characteristics element having the LLI Requested subfield.

14. The method of claim 13, wherein the LLI setup response frame further comprises an SCS ID, a QoS characteristics element, and a status code field.

15. The method of claim 12, wherein the LLI setup request frame is a Link Reconfiguration ML frame or an Operation Mode and Parameters (OMP) frame.

16. The method of claim 15, wherein the LLI setup request frame includes one or more parameter sets, wherein the one or more parameter sets include at least one of a QoS or an SCS ID to establish a use of the LLI mode using OMP frames.

17. The method of claim 12, wherein:
the LLI setup request frame is an SCS request frame; and
the SCS request frame includes in an SCS description element or a QoS characteristics element with an LLI Requested subfield equal to 1, wherein the LLI Requested subfield set to 1 indicates that the LLI mode is requested of the SCS streams described by a SCS description element or a QoS characteristics element and the LLI Requested subfield is set to 0 otherwise.

18. The method of claim 12, wherein:
the LLI setup request frame includes a maximum service interval field; and
when the LLI mode is enabled, if a direction subfield is set to 0, the maximum service interval field contains an unsigned integer that specifies a maximum interval between a start of two consecutive service periods (SPs) that are allocated to the non-AP STA for uplink (UL) frame exchanges and the maximum service interval field has a value of 0 when the LLI Requested subfield in a Control Info field is set to 1.

19. The method of claim 12, wherein:
the LLI setup request frame includes a minimum service interval field; and
when an LLI mode is enabled, if a direction subfield is set to 0, the minimum service interval field contains an unsigned integer that specifies a minimum interval between a start of two consecutive SPs that are allocated to the non-AP STA for uplink (UL) frame exchanges and the minimum service interval field has a value 0 when the LLI Requested subfield in a Control Info field is set to 1.

20. The method of claim 12, wherein:
the LLI Requested subfield is positioned in a Control Info field of a QoS characteristics element;
if there are multiple SCS request and response frames with an LLI Requested subfield indicating a use of the LLI mode is being requested, the LLI setup request frame indicates the use of the LLI mode for one or more of traffic that has been negotiated in one or more SCS request and response frames;
the non-AP STA negotiates one or more SCS with an LLI Requested field set to 1; and
the non-AP STA negotiates with more QoS characteristics elements in one SCS frame.
